(19) United States
(12) Patent Application Publication
(10) Pub. No.: US 2025/0173145 A1
(43) Pub. Date: May 29, 2025

(54) FILTERING BRANCH INSTRUCTION PREDICTIONS

(71) Applicant: Arm Limited, Cambridge (GB)

(72) Inventors: Rami Mohammad AL SHEIKH, Morrisville, NC (US); Houdhaifa BOUZGUARROU, Austin, TX (US)

(21) Appl. No.: 18/520,983

(22) Filed: Nov. 28, 2023

(51) Int. Cl. G06F 9/30; G06F 9/38

(52) U.S. Cl. CPC G06F 9/30058; G06F 9/30145; G06F 9/3846

(57) ABSTRACT

A data processing apparatus is provided. Decode circuitry decodes an instruction in a stream of instructions as a conditional branch instruction. Prediction circuitry performs a prediction of the conditional branch instruction in respect of a flow of the stream of instructions. Training circuitry receives and stores data associated with one or more executions of the conditional branch instruction. Generation circuitry generates the prediction based on the data and filter circuitry performs filtering to disregard a subset of the data, in dependence on whether the prediction is that the conditional branch instruction is of a specific type.

### TECHNICAL FIELD

The present disclosure relates to data processing and particularly the handling of branch predictions.

### DESCRIPTION

Conditional branch instructions alter the flow of control of a program based on some condition being met (e.g. a flag being equal to zero). Branch predictors can be used to predict the outcome (among other things) of such instructions. In practice, certain conditional instructions may always be taken if the condition is always met. When an instruction is determined to always be taken, it may generally be treated as an unconditional instruction—that is, predictions as to the outcome may not be performed and training may not be performed.

### SUMMARY

Viewed from a first example configuration, there is provided a data processing apparatus comprising: decode circuitry configured to decode an instruction in a stream of instructions as a conditional branch instruction; prediction circuitry configured to perform a prediction of the conditional branch instruction in respect of a flow of the stream of instructions, the prediction circuitry comprising: training circuitry configured to receive and store data associated with one or more executions of the conditional branch instruction, generation circuitry configured to generate the prediction based on the data; and filter circuitry configured to perform filtering to disregard a subset of the data, in dependence on whether the prediction is that the conditional branch instruction is of a specific type.

Viewed from a second example configuration, there is provided a method of data processing, comprising: decoding an instruction in a stream of instructions as a conditional branch instruction: performing a prediction of the conditional branch instruction in respect of a flow of the stream of instructions, by: receiving and storing data associated with one or more executions of the conditional branch instruction generating the prediction based on the data; and performing perform filtering to disregard a subset of the data, in dependence on whether the prediction is that the conditional branch instruction is of a specific type.

Viewed from a third example configuration, there is provided a non-transitory computer-readable medium to store computer-readable code for fabrication of a data processing apparatus comprising: decode circuitry configured to decode an instruction in a stream of instructions as a conditional branch instruction; prediction circuitry configured to perform a prediction of the conditional branch instruction in respect of a flow of the stream of instructions, the prediction circuitry comprising: training circuitry configured to receive and store data associated with one or more executions of the conditional branch instruction, generation circuitry configured to generate the prediction based on the data; and filter circuitry configured to perform filtering to disregard a subset of the data, in dependence on whether the prediction is that the conditional branch instruction is of a specific type.

### BRIEF DESCRIPTION OF THE DRAWINGS

The present invention will be described further, by way of example only, with reference to embodiments thereof as illustrated in the accompanying drawings, in which:

FIG. 1 shows an apparatus in accordance with some examples;

FIG. 2 shows an example of the branch target buffer and how it can be used to encode or record the type of the instruction;

FIG. 3A illustrates an example of a program containing a conditional branch instruction that is always-taken;

FIG. 3B shows a counter-example in which a branch is almost always-taken;

FIG. 4A shows a flowchart that illustrates a process in accordance with some examples in which mitigation against always-taken mispredictions occurs;

FIG. 4B shows an alternative process that uses counters in place of random numbers;

FIG. 5A shows a flowchart that shows a method of performing branch predictions with a ‘(potentially) always-taken’ categorisation:

FIG. 5B illustrates the promotion and demotion process in the form of a flowchart;

FIG. 6 shows a variant of FIG. 1 in which monitor circuitry is provided to track a number of times that always-taken predictions have been correct and to track a number of times that always-taken predictions have been incorrect:

FIG. 7 illustrates a method in which data throttling might be applied or removed;

FIG. 8 illustrates the idea of checkpointing and speculative execution:

FIG. 9 shows a further way in which always-taken instructions can be exploited for potential improvements in the pipeline;

FIG. 10 shows a third way in which the always-taken instruction can be used to potentially improve the pipeline;

FIG. 11 illustrates a flow chart that shows a method of data processing in accordance with some examples; and

FIG. 12 shows one or more packaged chips, with the apparatus implemented on one chip or distributed over two or more of the chips.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: decode circuitry configured to decode an instruction in a stream of instructions as a conditional branch instruction; prediction circuitry configured to perform a prediction of the conditional branch instruction in respect of a flow of the stream of instructions, the prediction circuitry comprising: training circuitry configured to receive and store data associated with one or more executions of the conditional branch instruction, generation circuitry configured to generate the prediction based on the data; and filter circuitry configured to perform filtering to disregard a subset of the data, in dependence on whether the prediction is that the conditional branch instruction is of a specific type.

A conditional branch instruction can be considered to be an instruction that conditionally alters the flow of control of the program (i.e. so that it is not strictly sequential). Although the branch instruction is said to conditionally alter the flow of control, the condition in question may be one that, in practice, is always met. Nevertheless, because the instruction is encoded as a condition, the condition may be evaluated and tested at each instance of that instruction to see whether the branch should occur or not. Since these instructions are conditional, it is possible to make predictions about the instruction. Such predictions might be of a behaviour of the conditional branch instruction such as whether a block of instructions contains a conditional branch instruction, whether a conditional branch instruction will be taken or not, or to where a conditional branch instruction will branch to (if it branches). The predictions can be improved by the use of training. That is, the collection of data associated with (previous) executions of the conditional branch instruction makes it possible to make informed predictions about a future of that instruction. In these examples, filtering circuitry is provided that disregards some of the data that is used for training. In some examples, some but not all of the data is disregarded. That is, another portion of the data is used. The disregarding could be achieved by the data not being generated, the data not being provided to the training circuitry, the training circuitry not storing the data or making updates based on the data, to the data being stored but intentionally not used for making predictions. Regardless of the form that the filtering takes, the filtering occurs based on the type of the conditional branch instruction. That is, some types of conditional branch instruction will attract the filtering, whereas other types of conditional branch instruction will not attract the filtering.

In some examples, the specific type is always-taken. Although a conditional branch instruction branches in dependence on some condition, it may be that the condition in question will always be met. This does not necessarily remove the need for the data processing apparatus to evaluate and test whether the condition is met—it merely means that from a statistical standpoint, the condition will always be met and that fact may not be visible to the data processing apparatus. Instructions that are suspected or actually work in this way can be described as always-taken.

In some examples, the filter circuitry is configured to probabilistically perform the filtering. In these examples, the data that is selected to be disregarded is selected based on a probability and a random event.

In some examples, the filter circuitry is configured to probabilistically perform the filtering to disregard the subset of the data when the prediction is that the conditional branch instruction is always-taken. When it is determined (albeit possibly incorrectly) that an instruction is an always-taken conditional branch instruction then some of the data can be disregarded so that it does not affect the training. In some examples, only some of the data is disregarded so that training still occurs. In some cases, training may be considered to be wasteful for an instruction that is expected to always be taken because the training may give no further information. However, if it is later determined that an instruction that was considered to be always-taken is not always-taken then the training data that has been accumulated may be useful in understanding when the instruction is taken and is not taken.

In some examples, the subset of the data is N in M of the data. N and M are both integers greater than 0 with N<M. The N in M can be determined using, for instance, counter circuitry to count N times that data is disregarded. Further data (until M items of data are encountered) is then not disregarded and can be used for training. Once M items of data are encountered, the process begins again.

In some examples, the data processing apparatus comprises: monitor circuitry configured to monitor an accuracy of the prediction circuitry in the prediction being that the conditional branch instruction is always-taken. The monitor circuitry can therefore be used to monitor and determine how accurate predictions are that a given conditional branch instruction is always-taken. There are a number of ways that this measurement can be made. For instance, the metric might consider only correct predictions and disregard incorrect predictions, or the incorrect predictions might count against the correct predictions, or indeed, the two values might be given as a tuple. The determination might consider a ratio or an absolute value. Other options are of course also available.

In some examples, a size of the subset of the data is determined according to the accuracy.

In some examples, the subset of the data is determined randomly. Rather than maintaining a counter, each time data is encountered, it is disregarded with some random probability. This means that counter circuitry (and a counter value) need not be maintained.

In some examples, the generation circuitry is configured to generate the prediction that the conditional branch instruction is always-taken, in response to the data being empty. When there is no data available for a conditional branch instruction, e.g. when that conditional branch instruction is encountered for the first time, the default assumption may be that the conditional branch instruction is always-taken until it is determined otherwise. This can be an efficient assumption since only a single transition can occur (e.g. from always-taken back to regular conditional branch instruction if an always-taken instruction is not taken at some point).

In some examples, the prediction circuitry is configured to generate the prediction that the conditional branch instruction is potentially always-taken, in response to the data being empty. Rather than conclude that a newly seen conditional branch instruction (e.g. one with no data) is always-taken, one could instead categorise such an instruction as potentially always-taken. Such an instruction could be treated as a regular conditional branch instruction (e.g. with a prediction being made as to the instruction) until it is promoted to being an always-taken instruction. This reduces the frequency with which instructions are demoted from being always-taken to regular conditional branch instructions since some evidence is acquired that the instruction is always-taken before concluding so.

In some examples, the prediction circuitry is configured to generate the prediction that the conditional branch instruction that is potentially always-taken is not-always-taken in response to the prediction circuitry receiving a not-taken datum that conditional branch instruction that is potentially always-taken is not taken during execution. A potentially always-taken instruction therefore becomes ‘demoted’ in response to a datum that the instruction was not taken. Since an always-taken instruction can never be not taken, even a single datum that the instruction was not taken is sufficient to perform the demotion.

In some examples, the prediction circuitry is configured to probabilistically generate the prediction that the conditional branch instruction that is potentially always-taken is always-taken. The ‘promotion’ of a conditional branch instruction from potentially always-taken to always-taken may or may not happen at any particular stage.

In some examples, the prediction circuitry is configured, in response to the prediction circuitry receiving a taken datum that the conditional branch instruction that is potentially always-taken is taken, to generate the prediction that the conditional branch instruction that is potentially always-taken is always-taken, based on whether a random number is less than an upgrade threshold. The upgrade threshold defines the probability with which the upgrade will occur. Meanwhile, the upgrade occurs based on random chance each time it is determined that a potentially-taken conditional branch instruction is actually taken. Thus, as a conditional branch instruction is taken more and more, it becomes increasingly likely that the instruction will have been promoted from potentially always-taken to always-taken.

In some examples, the upgrade threshold is dynamically set according to an accuracy of the prediction circuitry in making the prediction that the conditional branch instruction is always-taken. In these examples, the accuracy of the prediction that the conditional branch instruction is always-taken is monitored. This can be achieved by looking at the number of times an instruction that is considered to be always-taken is reverted back to being a regular conditional branch instruction. This number can be compared to a number of times that an instruction is upgraded to being always-taken (from potentially always-taken). Based on this comparison, for instance, the upgrade threshold can be changed. For instance, if the predictions are considered to be accurate, then the threshold might be increased whereas if the predictions are incorrect then the threshold can be decreased. A number of techniques exist for refining the threshold, but in some cases, this technique is simply trial-and-error until the prediction accuracy reaches a target amount. Alternatively, in some other examples, the upgrade threshold could be fixed.

In some examples, the prediction circuitry is configured to generate the prediction that the conditional branch instruction that is always-taken is a conditional branch instruction that is not always-taken in response to the prediction circuitry receiving a not-taken datum that the conditional branch instruction that is always-taken is not taken during execution. If a conditional branch instruction that is considered to be always-taken is at some point not taken, then the status of that branch instruction is reverted to being a regular conditional branch instruction. From there, a conditional branch instruction generally cannot be promoted back to always-taken or even potentially always-taken because there has been at least one occasion where the instruction was not taken and so it is important to carry out predictions on that instruction in the future.

In some examples, the data processing apparatus is configured, in response to the accuracy falling below a throttling threshold, to disregard any prediction that the conditional branch instruction is always-taken. In these examples, if the accuracy becomes too low then predictions as to whether a conditional branch instruction is always-taken or not is ignored and such instructions are therefore treated as simply being conditional branch instructions that are often taken.

In some examples, the data processing apparatus is configured, in response to the accuracy rising above a dethrottling threshold, to respect any prediction that the conditional branch instruction is always-taken. A separate dethrottling (e.g. proceeding) threshold may be defined. The dethrottling threshold will typically be equal to or higher than the throttling threshold so that a certain level of accuracy is required before the prediction regarding a conditional branch instruction being always-taken is followed. By providing a gap between the two thresholds, it is possible to avoid thrashing between ignoring predictions and accepting predictions rapidly. Larger gaps lead to a more stable system, but may make it difficult to reactivate always-taken actions after being throttled.

In some examples, the data processing apparatus comprises: storage circuitry configured to store an architectural state of the data processing apparatus in executing a stream of instructions including the conditional branch instruction, in response to the conditional branch instruction, wherein the storage circuitry is configured to provide the architectural state of the data processing apparatus in response to a flush event occurring; and the storage circuitry is configured to inhibit storing the architectural state of the data processing apparatus in response to the prediction that the conditional branch instruction is always-taken. The architectural state of a data processing apparatus includes intermediate values stored in (for instance) registers that is used during the execution of instructions. The architectural state might also include mappings of, for instance, virtual registers to physical registers as might be used in a rename stage. Where branch prediction occurs, it is typically necessary to store a snapshot of the architectural state so that if the prediction is incorrect, the previous architectural state (prior to the prediction being made) can be restored (by performing a flush followed by a restore). This process consumes storage and there is a limit to the number of snapshots that can be stored in this way. When it is determined that an always-taken conditional branch instruction is being executed, such a snapshot may not be generated. This can speed up execution of the branch instruction, reduce power consumption, and save storage space. In theory, since the conditional branch instruction is always-taken, the prediction should be a certainty and so a precautionary snapshot should not be needed. In practice, of course, it may never be provable that a conditional branch instruction will always be taken and so in the event that a supposedly always-taken conditional branch instruction is not taken, a flush can be performed and a rewind or restore can be taken to an even earlier snapshot. This even earlier snapshot might be to an earlier branch instruction or in some embodiments, a snapshot may be taken after every L instructions have executed.

In some examples, the data processing apparatus comprises: scheduling circuitry configured to schedule a stream of instructions including the conditional branch instruction for execution, wherein the scheduling circuitry is configured to reduce a priority with which the conditional branch instruction is selected for execution in response to the prediction that the conditional branch instruction is always-taken. In data processing apparatuses, there may be a number of instructions ready for execution at the same time. In these examples, an instruction that is considered to be an always-taken conditional branch instruction is deprioritised below regular conditional branch instructions. This is because of the expectation that a conditional branch instruction is more likely to be incorrectly predicted than an always-taken conditional branch instruction (for which the prediction should be a certainty). In general, it is better to get such predictions incorrect as quickly as possible so that the length of rewind that must be performed is limited and so that the correct flow of control can be entered as quickly as possible.

Particular embodiments will now be described with reference to the figures.

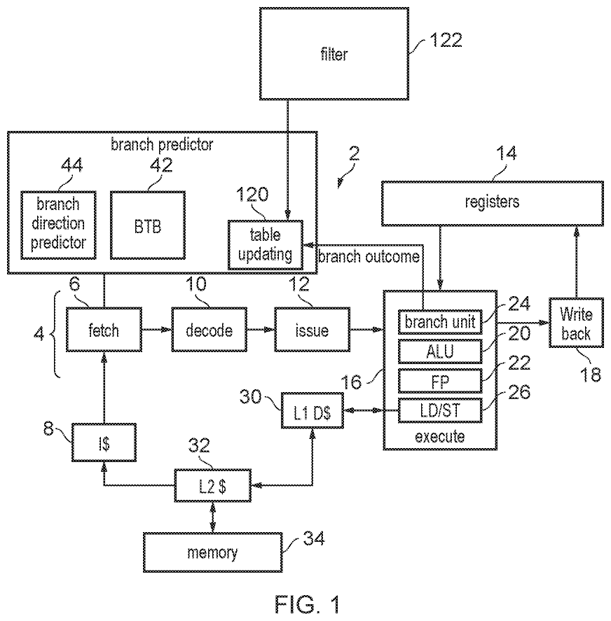

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8: a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available: an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14: a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

As shown in FIG. 1, the apparatus 2 includes a branch direction predictor 44, which is an example of the claimed prediction circuitry, for predicting outcomes of branch instructions. The branch predictor is looked up based on addresses of instructions provided by the fetch stage 6 and provides a prediction on whether those instructions are predicted to include branch instructions, and for any predicted branch instructions, a prediction of their branch properties such as a branch type, branch target address and branch direction (predicted branch outcome, indicating whether the branch is predicted to be taken or not taken). The branch predictor 40 includes a branch target buffer (BTB) 42 for predicting properties of the branches other than branch direction, and a branch direction predictor (BDP) 44 for predicting the not taken/taken outcome (branch direction) (the BDP is an example of the claimed generation circuitry). It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

As shown in FIG. 1, the branch predictor may have table updating circuitry 120 which receives signals from the branch unit 24 indicating the actual branch outcome of instructions, such as indications of whether a taken branch was detected in a given block of instructions, and if so the detected branch type, target address or other properties. If a branch was detected to be not taken then this is also provided to the table updating circuitry 120. The table updating circuitry 120 then updates state within the BTB 42, the branch direction predictor 44 and other branch prediction structures to take account of the actual results seen for an executed block of instructions, so that it is more likely that on encountering the same block of instructions again then a correct prediction can be made. The table updating circuitry 120 is an example of the claimed training circuitry.

FIG. 1 also includes filter circuitry 122. The filter circuitry performs filtering so that some of the data that is used for training purposes is disregarded. In this specific example, the disregarded data is killed by the table updating circuitry 120 itself and is not used to update the BTB 42, for instance. The filtering that takes place depends on a type of branch instruction executed by the branch unit 24. In particular, the filtering depends on a type of conditional branch instruction that the branch unit 24 executes.

There are a number of ways of recognising the type of conditional branch instruction—e.g. always-taken or (as described later) potentially always-taken.

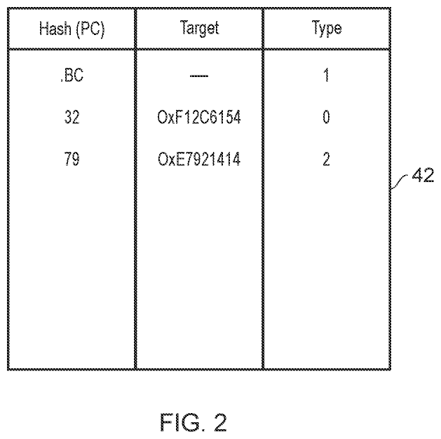

FIG. 2 shows an example of the BTB 42 and how it can be used to encode the type of the instruction. Each entry in the BTB is indexed by the hash of a program counter value (e.g. the least significant 8 bits). The BTB in this example also stores the predicted target for that branch instruction, and the type of the instruction. In this case, the encoding of type may be provided as ‘0’ being equivalent to a regular conditional instruction that is neither “always-taken” nor potentially “always-taken”), ‘1’ being equivalent to an always-taken instruction, and ‘2’ being equivalent to a potentially always-taken instruction. There are a number of ways that an instruction can acquire a particular type as will be discussed below. However in some examples, a conditional instruction that is seen for the first time (e.g. when there is no existing data) is initially considered to be an always-taken instruction until demonstrated otherwise. If that instruction is ever not taken then the instruction can be ‘demoted’ down to a conditional instruction.

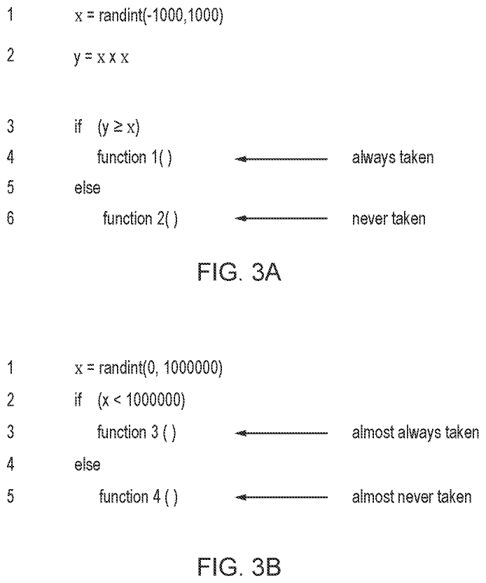

FIG. 3A illustrates an example of a program containing a conditional branch instruction that is always-taken. In line 1 of the program, x is set to a random integer between −1000 and 1000 (inclusive). The actual distribution here is irrelevant for the purposes of understanding. At line 2, the variable y is set to x multiplied by itself (i.e. x²). Mathematically, it will be appreciated that y is therefore always positive. Therefore for any negative value of x, y will always be larger (being positive). When x is 0, y will be equal (at 0). For any positive integer, the square of the integer is always larger than the integer itself. Therefore, under all circumstances, we know that y will be at least as big as x. Line 3 of the program asks whether y is larger than or equal to x. If so, then function1 is called, otherwise (if y is less than x), function2 is called. As explained, y is always larger than x. Therefore, function1 will be called and function2 will never be called.

In practice, the ‘if’ statement at line 3 is a conditional branch instruction. It provides a condition and if the condition is met then a branch occurs. Otherwise, that branch does not occur (instead, another branch occurs at line 6). In practice, in many data processing apparatuses, this test will be performed and evaluated on at every execution. However we know that, mathematically, the condition at line 3 will always be met. Thus, the conditional nature of this conditional branch instruction is debatable. It is an always-taken conditional instruction.

FIG. 3B shows a counter-example in which a branch is almost always-taken. At line 1, the variable x is assigned a random integer between 0 and 1000000 (inclusive). At line 2, it is determined whether x is strictly less than 1000000. If so, function3 is called. Otherwise function4 is called. There is, in practice, only a one-in-a-million chance that function3 will be called. Thus, it may appear to always be taken. In practice, however, it is merely ‘nearly’ always-taken and is not actually always-taken. The branch instruction on line 2 is therefore merely a conditional instruction.

If it is known that a conditional instruction is actually always-taken then the instruction can be treated differently to a regular conditional instruction. For instance, it may not be necessary to perform direction prediction.

In general, it is desirable to identify an always-taken conditional branch instruction as soon as possible so that any efficiencies that can be gained can be used as soon as possible. However, this can cause the problem that if an instruction that was classified as always-taken is later to not always be taken, then training the prediction circuitry to predict the circumstances in which that conditional instruction is taken (and when it is not taken) must start from the beginning. This can lead to a period in which it is not possible to produce predictions in respect of the conditional branch instruction. During that time, an increased number of mispredictions may occur.

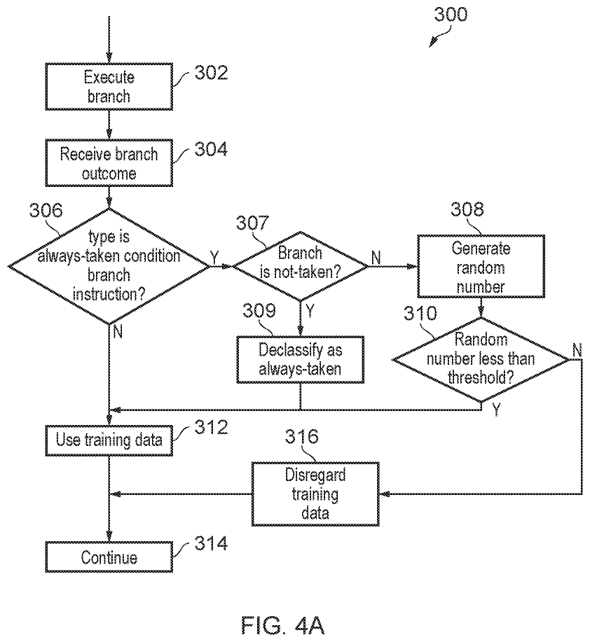

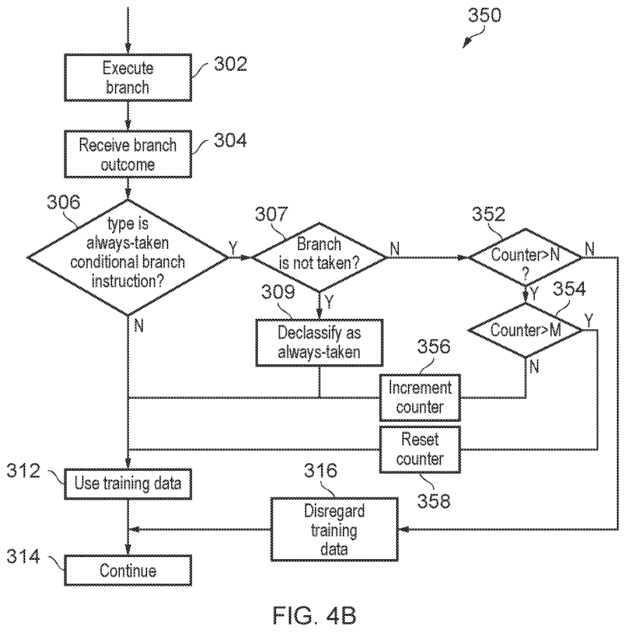

FIG. 4A shows a flowchart 300 that illustrates a process that can be used to mitigate this. At step 302, a branch instruction is executed (e.g. by the branch unit 24). Then at step 304, training data (e.g. the branch outcome) is received. At step 306, it is determined whether the type of the branch instruction that was executed is a conditional branch instruction that is considered to be always-taken (or, as will be discussed later, potentially always-taken). If not, then the training process proceeds as normal, which is to say that the training data is used at step 312 and the process continues at step 314 (ending when the program ends). Alternatively, if the instruction is a branch instruction that is considered (potentially) always-taken then at step 306, it is determined whether the branch outcome indicates that the (potentially) always-taken conditional branch instruction is not taken. If so, then the instruction that was considered to be (potentially) always-taken has not been taken and so at step 309 the instruction's classification is ‘demoted’ to being merely a conditional instruction and the process proceeds to step 312 as previously discussed. If the instruction was taken at step 307 then at step 308, a random number is generated. If, at step 310, this random number is less than a threshold value then the training data is used at step 312 as previously discussed. Otherwise, at step 316 the training data is disregarded and the process continued at step 314 as previously discussed.

The disregarding of the training data may take many forms. In some cases, the training data is simply dropped and not used. In other examples, the training data may be stored but not used to update any state. In some examples, the training data may not even be generated. In each case, of course, while the instruction remains considered to be always-taken, predictions as to the outcome of the branch instruction may continue to not be made (since the instruction is considered to not always be taken).

The above technique makes it possible to probabilistically make use of training data so that if the conditional branch that is considered to be always-taken is ever not taken, then some training data will be available with which to start making predictions. By adjusting the threshold in step 310, it is possible to control how readily training is performed. As the threshold drops, more training data will be available. However, some of the advantages associated with identifying always-taken conditional branch instructions—such as saving energy from not performing training can be lost or reduced.

FIG. 4B shows an alternative process that uses counters in place of random numbers. For simplicity the same reference numerals are used for steps of the process that are largely unchanged and those steps are not repeated here. When, at step 307, a (potentially) always-taken branch is evaluated to be taken, it is determined at step 352 whether a counter is greater than a first threshold value N. If not then the training data is disregarded at step 316 and the process continues at step 314. If the counter is greater than N, then the flow proceeds to step 354 where it is determined whether the counter is greater than M. If not, the counter is incremented at step 356 and the training data is used at step 312. Otherwise, if the counter is greater than M, the counter is reset at step 358 and the training data is used at step 312.

In this way the counter is maintained so that N out of M contiguous items of training data are disregarded, while (M-N) of the M contiguous items of training data are used.

Rather than maintain two counters, a single counter can be used to cause only every N'th value to be used for training, with other values being disregarded. In this situation, the first threshold value is kept and indicates how many taken branches are disregarded before the next taken branch is used for training. When the counter reaches N, the counter is reset and that item of data is used for training. Of course, rather than setting a threshold, the counter could simply be implemented so that the first threshold is equal to the counter's maximum value. When the counter saturates and returns to 0, the next item of data can be used for training.

In some embodiments, when a miss occurs in the BTB for a conditional instruction, the instruction is treated as an always-taken instruction (until such time as the instruction is determined to not be taken). This, however, can result in mispredictions. Rather than immediately classify an instruction as always-taken, one could take a slower approach by initially classifying it as ‘potentially always-taken’ until it has been taken a number of times, at which point it can be promoted to being ‘always-taken’.

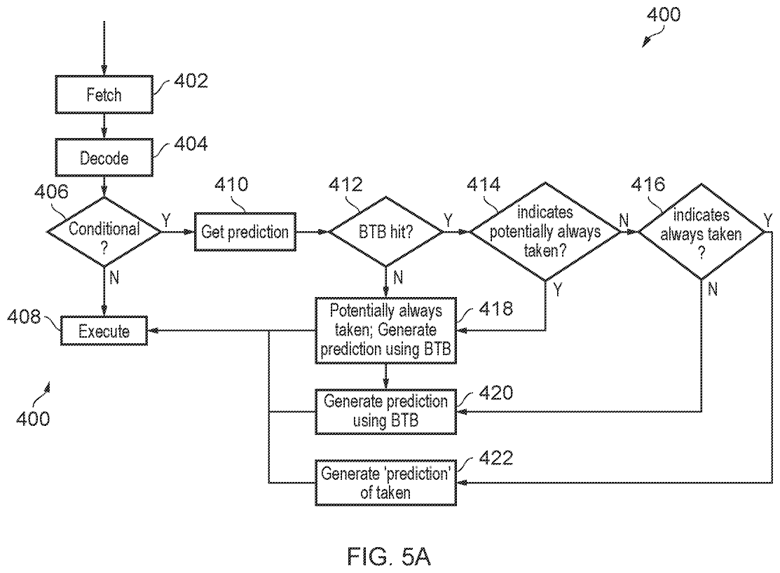

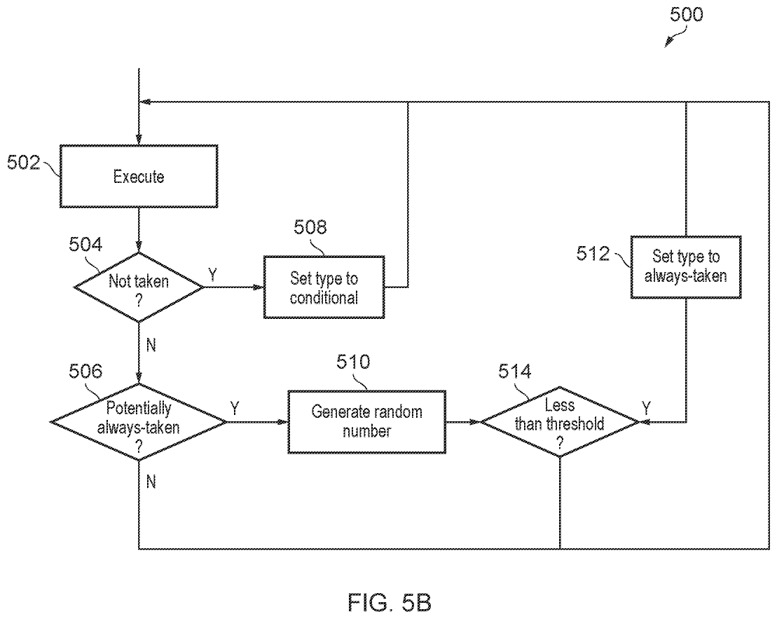

FIG. 5A shows a flowchart 400 that shows a method of performing branch predictions with a ‘(potentially) always-taken’ categorisation. The process begins at a step 402 where the instruction is fetched and then at step 404 the instruction is decoded. At step 406, it is determined whether the instruction is a conditional instruction. If not, then at step 408 the instruction is forwarded through the pipeline for execution. Otherwise at step 410, the prediction is obtained by querying the BTB. If there is no hit in the BTB at step 412, then it is assumed that the instruction is potentially always-taken and the instruction then executes at step 408. Otherwise, at step 414, if there is a hit, it is determined whether the instruction is considered to be potentially always-taken by the BTB. If so, then again, the instruction is considered potentially always-taken at step 418 but to other intents and purposes is treated as a conditional branch instruction in which a prediction is made using prediction generation circuitry (e.g. such as a TAGE predictor). Otherwise, it is determined whether the BTB considers the instruction to be always-taken at step 416. If not, then the instruction is simply a regular conditional instruction (i.e. not always-taken or potentially always-taken) and so the prediction is made using prediction generation circuitry (e.g. a TAGE predictor or a local history predictor using a saturated counter). Again, the instruction is then executed at step 408. Finally, if the instruction is indicated as being always-taken by the BTB at step 416 then the process proceeds to step 422 where a ‘prediction’ that the instruction is always-taken is made. This does not necessitate the use of any prediction generation circuitry. The instruction then executes at step 408.

Consequently, an instruction begins life as ‘potentially always-taken’ and either becomes always-taken or becomes a regular conditional instruction.

FIG. 5B illustrates the promotion and demotion process in the form of a flowchart 500. At a step 502, the conditional instruction is executed. At a step 504, it is determined whether the instruction is taken or not. If the instruction is not taken, then the type is set to conditional at step 508 (if it isn't already) and the process returns to step 502. Alternatively, if the instruction is taken, then at step 506, it is determined whether the instruction is considered to be potentially always-taken at step 506. If so, then at step 510 a random number is generated and if, at step 514, it is determined that the random number is less than an upgrade threshold then the instruction is promoted to always-taken at step 512 before the process returns to step 502. Otherwise, if the random number is greater than the upgrade threshold, then the directly returns to step 502 without promotion or demotion.

Note that in this system, there is no way for a conditional instruction to return to being potentially always-taken precisely because an instruction only becomes conditional if it is ever not taken (at which point it cannot be said that the instruction is always-taken). Other than that, an instruction is promoted to being always-taken (from potentially always-taken probabilistically, that is based on some random number and an upgrade threshold).

As previously discussed, the outcome may be used to perform table updating 120 depending on the type of the conditional instruction. The upgrading of the type of the instruction is stored in the BTB 42.

The upgrade threshold might be set at a fixed point. However, in some embodiments, the success rate of promotions can be monitored in order to dynamically set or adapt the upgrade threshold.

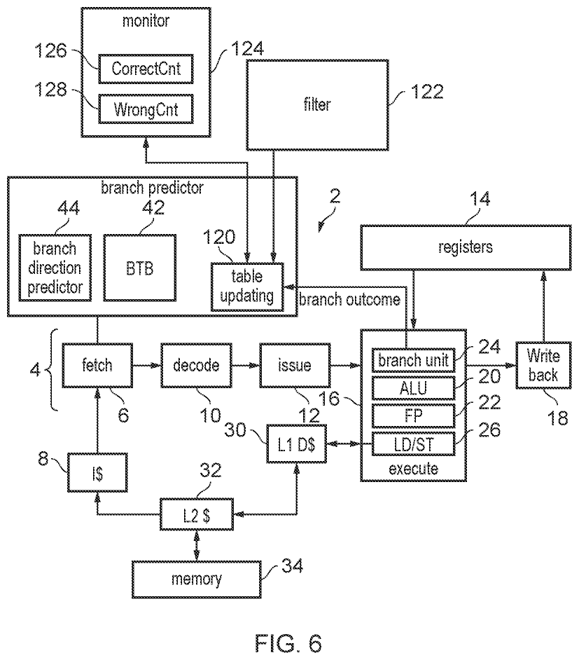

In particular, FIG. 6 shows a variant of FIG. 1 in which monitor circuitry 124 is provided to track (using a correct counter 126) a number of times that always-taken predictions have been correct and to track (using an incorrect counter 128) a number of times that always-taken predictions have been incorrect. These determinations can be made from table updating circuitry 120, which receives indications from the branch unit 24 as to the outcome of a conditional branch instruction (e.g. whether it was taken or not).

In these examples, throttling of the system can take place when predictions are generally incorrect and the throttling can be ended when predictions are generally correct. The throttling can take a number of forms but can, for instance, directly tie in to the promotion threshold described with reference to FIG. 5B (e.g. so that as prediction accuracy increases, the threshold required to achieve promotion is lowered-possibly to some limit).

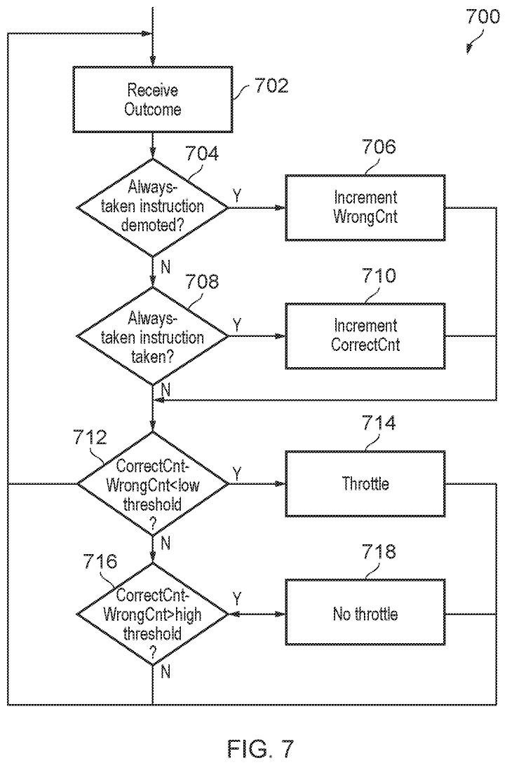

FIG. 7 illustrates a method in which data throttling might be applied or removed. Here it is assumed that there are two thresholds—a lower threshold below which throttling will be applied and an upper threshold above which throttling will not be applied. The high threshold is clearly at least equal to if not greater than the lower threshold. It is assumed (but not necessary) that there is a gap between the two thresholds in order to avoid thrashing in which throttling is continually enabled and disabled.

The process begins at step 702 where the outcome of a conditional instruction (of any type). At step 704, it is determined whether the instruction is an always-taken conditional instruction that is being demoted (i.e. due to being not taken). If so, then the WrongCnt counter is incremented and the process proceeds to step 712. Otherwise, at step 708, it is determined if the instruction is an always-taken conditional instruction that is taken. If so, then the CorrectCnt counter is incremented and the process proceeds to step 712. Otherwise at step 712, the value of CorrectCnt−WrongCnt is less than the lower threshold. If so then at step 714, throttling occurs and the process returns to step 702. Otherwise, at step 716 it is determined whether the value of CorrectCnt−WrongCnt is greater than the high threshold. If so then at step 718, throttling is disengaged. In either case, the process then returns to step 702.

The throttling can take a number of forms. For instance, while throttled, newly discovered conditional branch instructions may be generated in the potentially always-taken state (as shown in FIG. 5A) rather than the always-taken state. Alternatively or in addition, while throttled, always-taken instructions might be treated as regular conditional branch instructions. That is to say that training may be performed (non-probabilistically), and that predictions may be generated (e.g. using TAGE predictors) for the outcome of the always-taken conditional branch instruction. Other actions can of course also be taken.

It will be appreciated that here a simple subtraction of WrongCnt from CorrectCnt is performed in order to compare to the thresholds. Of course, other comparisons are also possible such as comparing a ratio (rather than the subtraction) to the two thresholds.

It is possible to make improvements to the pipeline 4 using the prediction that a conditional instruction is an always-taken instruction. Three ways in which this can be done are illustrated here, including: Checkpointing for branches, deprioritisation of always-taken branches, and constructing 2T pairs.

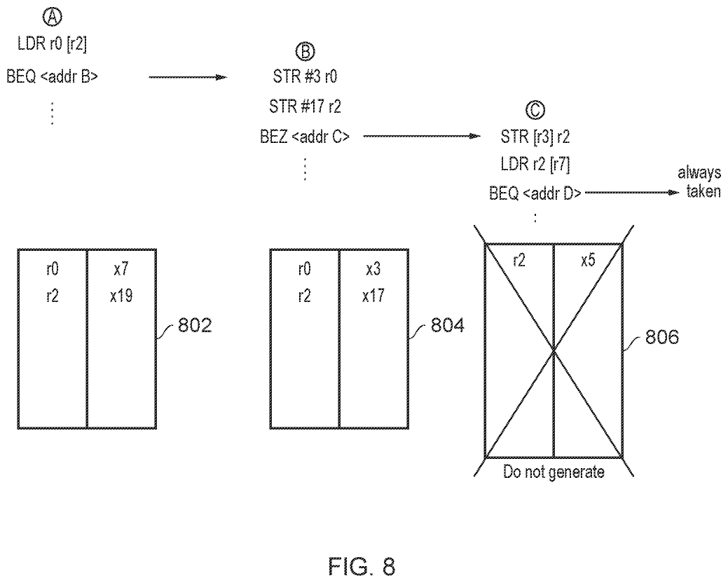

FIG. 8 illustrates the idea of checkpointing and speculative execution. At a conditional branch instruction, unless one is willing to allow the data processing apparatus to stall it may be necessary to speculatively follow a particular control flow path (e.g. to the target of the branch instruction) before it is known whether that decision is correct or not. Sometimes this prediction may be incorrect. It is therefore necessary to perform a ‘snapshot’ of the architectural state of the data processing apparatus prior to making the branch so that execution can be ‘rewound’ if the prediction is incorrect. This architectural state may include the values stored in registers that may be overwritten after the branch instruction.

There are a number of ways in which snapshots can be made. For instance, state can be saved using register renaming. Register renaming makes it possible to map the registers used and referenced in instructions to actual physical registers. By differentiating between these two concepts, it is possible to remove dependencies between registers. For example, the instruction prior to a branch and the instruction after a branch might both perform a write to a register r1. However, there is not necessarily any need for the instruction after the branch to overwrite the data value in register r1. Consequently, a virtual-to-physical mapping might cause the pre-branch instruction to actually write to a register x4 and the post-branch instruction to write to register x19. What changes before and after the branch is the mapping. That is, initially, register r1 refers to x4 and after the branch r1 refers to x19. By storing this sequence of changes, it is possible to rewind.

FIG. 8 illustrates the savings that can be made with regards to snapshots with speculative execution. In block of instructions A, a load instruction occurs that reads the contents of the memory address in register r2 into register r0. A conditional branch (branch if not equal to zero) then occurs to the address of block of instructions B. The state table 802 that is saved may include a mapping of logical register r0 to physical register x7 and a mapping of logical register r2 to physical register x19. Then, at block B, a first store instruction causes the value ‘3’ to be stored in register r0 and the value ‘17’ to be stored in register r2. Because block B may be executed speculatively (while the BEQ of block A is waiting to execute), a different mapping of logical registers to physical registers is used-consequently the physical registers that are written to in block A are not overwritten. Thus, in this state table 804, a mapping from logical register r0 to physical register x3 is shown and a mapping from logical register r2 to physical register x17 is shown. Note that if the speculative branching of the BEQ instruction in block A was found to be incorrect, then state can be restored because the previous mapping of registers in the first state table 802 has been kept. A further speculative execution may occur via a conditional branch instruction (branch if equal to zero) in block B, this time to the address of block C. Here yet another mapping of logical registers to physical registers is used. In particular, the logical register r2 is mapped to physical register x5 and yet another conditional branch instruction (branch if equal) occurs to the address of block D. This time, however, the conditional branch instruction is considered to be always-taken. As a consequence, the mapping of registers for the latest block (e.g. from logical register r2 to physical register x5) is not saved in the state table 806. This is because the conditional instruction is believed to always be taken and so it is assumed that no rewind will be necessary. If it transpires that the instruction is not always-taken (e.g. if the speculation was incorrect) this will necessitate a rewind back to the previous state table 804, which is larger than might normally take place. However, as stated, it is expected that the rewind should not occur.

This increases the speed with which the branch instruction in block C can be taken, because saving of the state in the state table 806 is not required. Furthermore, it saves storage space since the state table 806 is not used for that branch instruction.

In many data processing apparatuses, as well as saving the state in state tables 802 when speculative branches are encountered, the state is saved every X instructions. Consequently, the rewind that actually occurs if an always-taken conditional branch instruction is not taken is limited.

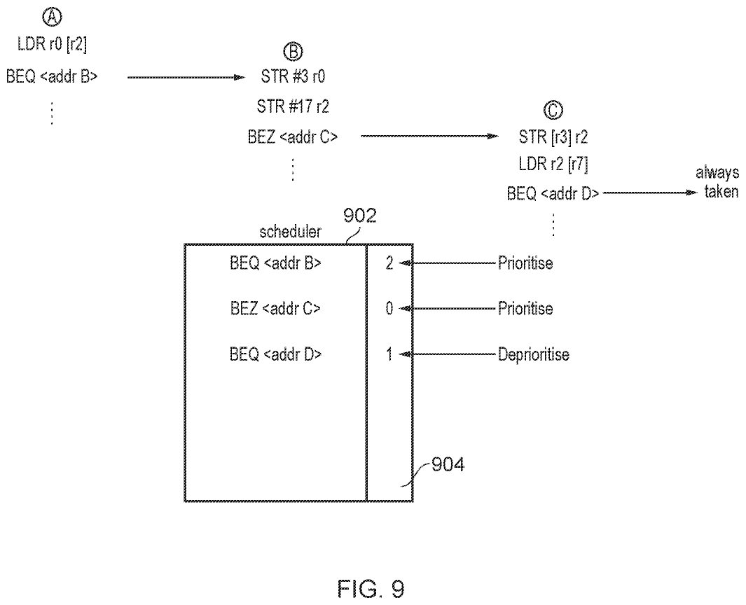

FIG. 9 shows a further way in which always-taken instructions can be exploited for potential improvements in the pipeline. In particular. FIG. 9 illustrates an example scheduler 902 that may be used at the issue stage 12, prior to the instruction being sent to one of the execution units 24, 20, 22, 26. In this example, the scheduler 902 shows only the branch instructions that would be sent to the branch unit 24. However, it will be appreciated that in practice, the scheduler would also show other types of instruction as well. In this example, an extra column 904 is shown to indicate whether the branch instruction is considered to be always-taken or not. Again, this is merely just an example implementation and in other systems, this ‘encoding’ might form part of the decoding process for instance. Here as before, the ‘1’ represents an always-taken instruction, the ‘O’ represents a regular conditional branch instruction, and a ‘2’ represents a potentially always-taken instruction. In this example, the always-taken instruction is deprioritised by the scheduler and will be lowered in priority as compared to the situation that would arise if the same instruction was conditional or potentially always-taken.

In this way, the conditions that are more likely to cause a rewind (which causes disruption to the data processing apparatus) are executed quickly-thereby limiting the disruption caused by a rewind should it occur. In contrast, the more confident instructions (e.g. the always-taken conditional branch instruction) is executed later since it is less likely that any disruption will occur.

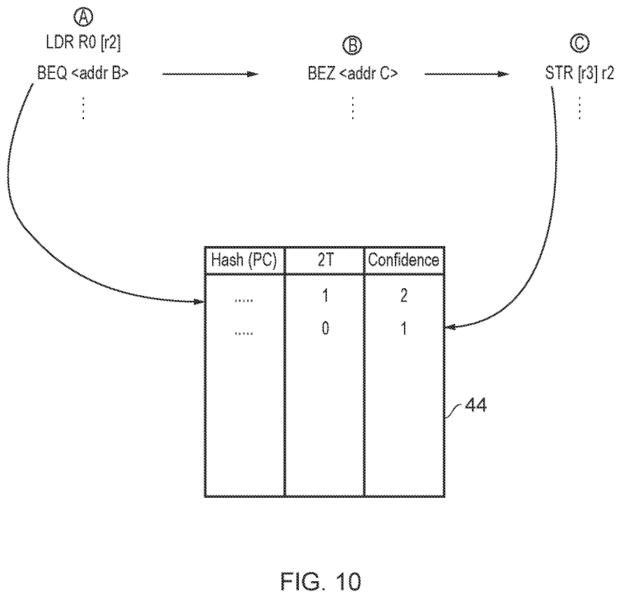

FIG. 10 shows a third way in which the always-taken instruction can be used to potentially improve the pipeline, and this is in the detection and training of what is known as 2T entries. As shown in FIG. 10, it is possible that one branch instruction (if taken) will cause the program flow to jump to another branch instruction (or perhaps a block of instructions containing another branch instruction). If both instructions are generally considered to be taken then space can be saved in the branch direction predictor by grouping the two branch instructions together into a single entry. For instance, if it is predicted that the BEQ instruction in block A will be taken and the BEZ instruction in block B will be taken (with the BEQ instruction causing a branch to the BEZ instruction) then one could store both predictions as a single entry in the branch direction predictor 44 with the prediction that the effect of the branch instruction BEQ in block A is actually a branch to block C. Of course, both branch instructions will have to be executed—the prediction is merely for predicting which further instructions to fetch, decode, and execute until such time as those branches can be executed.

The training of such a branch direction predictor 44 is beyond the scope of this document. However, it will be appreciated that this can be naively implemented in (for instance) a simple branch predictor when the confidence of the constituent branches reaches a maximum confidence value (‘2’ in the example of FIG. 10). Provided both branches continue to be taken, those branches can be kept together as a single entry (and then separated should one of the two branches not be taken). Clearly in these situations, an always-taken conditional branch instruction can speed up the detection of such 2T pairs since it is considered to be always-taken and therefore can be immediately paired with any instruction branching to it or from it.

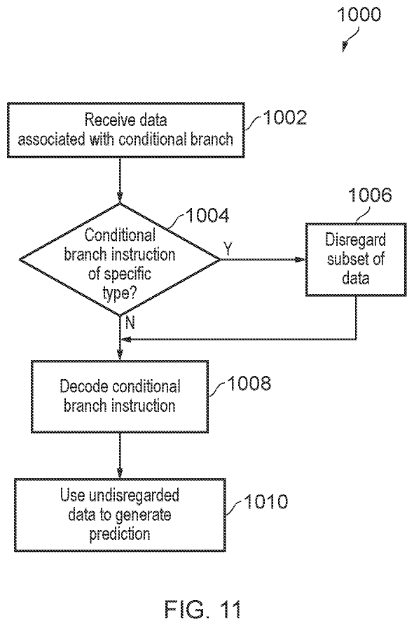

FIG. 11 illustrates a flow chart 1000 that shows a method of data processing in accordance with some examples. At a step 1002, data is received that is associated with a conditional branch instruction. Then at step 1004, it is determined whether the conditional branch instruction is of a specific type. If so, then at step 1006, a subset of the data is disregarded. In any event, at step 1008, when it is encountered, the conditional branch instruction is decoded. Then at step 1010, any undisregarded data is used to generate the prediction.

It will be appreciated that this process is simple one example of the flow that might occur and other examples are of course possible.

Note that the examples above provide a number of distinct and optionally combinable techniques, but this does not necessitate that those techniques must be combined. For instance, although FIGS. 4A and 4B do not describe the use of potentially always-taken instructions, they can clearly be combined with this technique by simply treating them as conditional branch instructions that are not always-taken.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

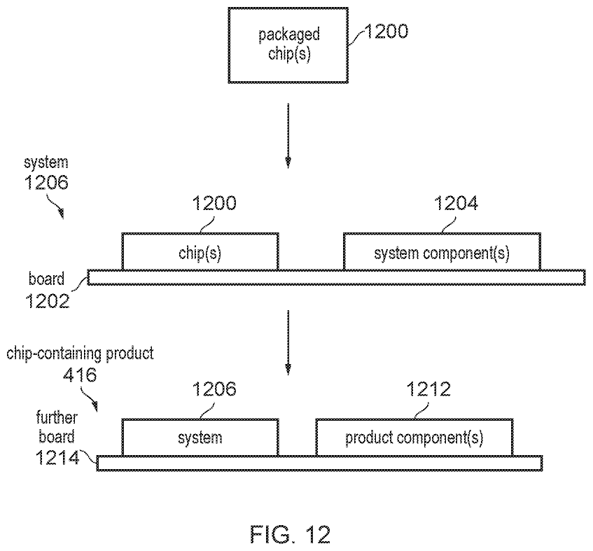

As shown in FIG. 12, one or more packaged chips 1200, with the apparatus described above implemented on one chip or distributed over two or more of the chips, are manufactured by a semiconductor chip manufacturer. In some examples, the chip product 1200 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 1200 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 1200 are assembled on a board 1202 together with at least one system component 1204 to provide a system 1206. For example, the board may comprise a printed circuit board. The board substrate may be made of any of a variety of materials, e.g. plastic, glass, ceramic, or a flexible substrate material such as paper, plastic or textile material. The at least one system component 1204 comprise one or more external components which are not part of the one or more packaged chip(s) 1200. For example, the at least one system component 1204 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 1216 is manufactured comprising the system 1206 (including the board 1202, the one or more chips 1200 and the at least one system component 1204) and one or more product components 1212. The product components 1212 comprise one or more further components which are not part of the system 1206. As a non-exhaustive list of examples, the one or more product components 1212 could include a user input/output device such as a keypad, touch screen, microphone, loudspeaker, display screen, haptic device, etc.; a wireless communication transmitter/receiver: a sensor; an actuator for actuating mechanical motion; a thermal control device: a further packaged chip: an interface module: a resistor: a capacitor: an inductor: a transformer: a diode; and/or a transistor. The system 1206 and one or more product components 1212 may be assembled on to a further board 1214.

The board 1202 or the further board 1214 may be provided on or within a device housing or other structural support (e.g. a frame or blade) to provide a product which can be handled by a user and/or is intended for operational use by a person or company.

The system 1206 or the chip-containing product 1216 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television. DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog. Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus comprising:
decode circuitry configured to decode an instruction in a stream of instructions as a conditional branch instruction;
prediction circuitry configured to perform a prediction of the conditional branch instruction in respect of a flow of the stream of instructions, the prediction circuitry comprising:
training circuitry configured to receive and store data associated with one or more executions of the conditional branch instruction,
generation circuitry configured to generate the prediction based on the data; and
filter circuitry configured to perform filtering to disregard a subset of the data, in dependence on whether the prediction is that the conditional branch instruction is of a specific type.

2. The data processing apparatus according to claim 1, wherein
the specific type is always-taken.

3. The data processing apparatus according to claim 2, wherein
the filter circuitry is configured to probabilistically perform the filtering.

4. The data processing apparatus according to claim 1, wherein
the filter circuitry is configured to probabilistically perform the filtering to disregard the subset of the data when the prediction is that the conditional branch instruction is always-taken.

5. The data processing apparatus according to claim 4, wherein
the subset of the data is N in M of the data.

6. The data processing apparatus according to claim 1, comprising:
monitor circuitry configured to monitor an accuracy of the prediction circuitry in the prediction being that the conditional branch instruction is always-taken.

7. The data processing apparatus according to claim 6, wherein
a size of the subset of the data is determined according to the accuracy.

8. The data processing apparatus according to claim 1, wherein
the generation circuitry is configured to generate the prediction that the conditional branch instruction is always-taken, in response to the data being empty.

9. The data processing apparatus according to claim 1, wherein
the prediction circuitry is configured to generate the prediction that the conditional branch instruction is potentially always-taken, in response to the data being empty.

10. The data processing apparatus according to claim 9, wherein
the prediction circuitry is configured to generate the prediction that the conditional branch instruction that is potentially always-taken is not-always-taken in response to the prediction circuitry receiving a not-taken datum that the conditional branch instruction that is potentially always-taken is not taken during execution.

11. The data processing apparatus according to claim 9, wherein
the prediction circuitry is configured to probabilistically generate the prediction that the conditional branch instruction that is potentially always-taken is always-taken.

12. The data processing apparatus according to claim 9, wherein
the prediction circuitry is configured, in response to the prediction circuitry receiving a taken datum that the conditional branch instruction that is potentially always-taken is taken, to generate the prediction that the conditional branch instruction that is potentially always-taken is always-taken, based on whether a random number is less than an upgrade threshold.

13. The data processing apparatus according to claim 12, wherein
the upgrade threshold is dynamically set according to an accuracy of the prediction circuitry in making the prediction that the conditional branch instruction is always-taken.

14. The data processing apparatus according to claim 10, wherein
the prediction circuitry is configured to generate the prediction that the conditional branch instruction that is always-taken is a conditional branch instruction that is not always-taken in response to the prediction circuitry receiving a not-taken datum that the conditional branch instruction that is always-taken is not taken during execution.

15. The data processing apparatus according to claim 1, wherein
the data processing apparatus is configured, in response to the accuracy falling below a throttling threshold, to disregard any prediction that the conditional branch instruction is always-taken.

16. The data processing apparatus according to claim 15, wherein
the data processing apparatus is configured, in response to the accuracy rising above a dethrottling threshold, to respect any prediction that the conditional branch instruction is always-taken.

17. The data processing apparatus according to claim 1, comprising:
storage circuitry configured to store an architectural state of the data processing apparatus in executing a stream of instructions including the conditional branch instruction, in response to the conditional branch instruction, wherein
the storage circuitry is configured to provide the architectural state of the data processing apparatus in response to a flush event occurring; and
the storage circuitry is configured to inhibit storing the architectural state of the data processing apparatus in response to the prediction that the conditional branch instruction is always-taken.

18. The data processing apparatus according to claim 1, comprising:
scheduling circuitry configured to schedule a stream of instructions including the conditional branch instruction for execution, wherein
the scheduling circuitry is configured to reduce a priority with which the conditional branch instruction is selected for execution in response to the prediction that the conditional branch instruction is always-taken.

19. A method of data processing, comprising:
decoding an instruction in a stream of instructions as a conditional branch instruction;
performing a prediction of the conditional branch instruction in respect of a flow of the stream of instructions, by:
receiving and storing data associated with one or more executions of the conditional branch instruction,
generating the prediction based on the data; and
performing perform filtering to disregard a subset of the data, in dependence on whether the prediction is that the conditional branch instruction is of a specific type.

20. A non-transitory computer-readable medium to store computer-readable code for fabrication of a data processing apparatus comprising:
decode circuitry configured to decode an instruction in a stream of instructions as a conditional branch instruction;
prediction circuitry configured to perform a prediction of the conditional branch instruction in respect of a flow of the stream of instructions, the prediction circuitry comprising:
training circuitry configured to receive and store data associated with one or more executions of the conditional branch instruction,
generation circuitry configured to generate the prediction based on the data; and
filter circuitry configured to perform filtering to disregard a subset of the data, in dependence on whether the prediction is that the conditional branch instruction is of a specific type.
